(19) United States
(12) Patent Application Publication
(10) Pub. No.: US 2006/0222801 A1
(43) Pub. Date: Oct. 5, 2006

(54) Protective film

(75) Inventor: Ryoichi Mase, Tokyo (JP)

Correspondence Address: Apex Juris, pllc, 13194 Edgewater Lane Northeast, Seattle, WA, 98125, US

(73) Assignee: Power Support Co., Ltd., Shibuya (JP)

(21) Appl. No.: 11/322,769

(22) Filed: Dec. 30, 2005

(30) Foreign Application Priority Data
Apr. 2, 2005 (JP) JP2005-001143U

(51) Int. Cl. B32B 33/00

(52) U.S. Cl. 428/40.1

(57) ABSTRACT

A protective film that covers a switch surface of an electronic device. The protective film has a first film with an adhesive surface to cover a surface of the electronic device and a second film superposed thereon to cover a predetermined portion of the electronic device. The protective film provides various advantages such as excellent scratch resistance, antifouling and dirt or stain resistantance.

### BACKGROUND OF THE INVENTION

1. Field of the Invention

This invention relates to a protective film for an electronic device. More particularly, this invention relates to a protective film for an electronic device, which has an adhesive layer and a non-adhesive layer to cover and protect a switch surface or a control surface of the electronic device.

2. Description of the Related Arts

A conventional screen protective film can be seen in U.S. RE35,318 to Warman. It discloses a removable and securable shield in association with such as LCD screens. The shield is removable and replaceable and includes convex peripheral edges to conform the shield to the convex screen with an outwardly extending tab formed outwardly of a single corner of the shield to enhance manual grasping thereof. To enhance securement of the shield to the associated screen, a plurality of transparent adhesive strips may be secured to an interior surface of the shield.

Due to the recent rapid development of screen film industry, demands for improvements on the screen film technology are increasing. A front surface of the electronic device may have various shapes. For example, the front surface may have a traditional flat screen surface, a switch surface area for turning on or off particular functions of the electronic device, and a sensing control surface for manually controlling the electronic device. It is a common knowledge that the protective shield covering the flat screen surface exists to cover and protect the screen from being scratched. There are various types and Warman is one of them. Also, it is common knowledge that the control and switch surfaces can easily be scratched and therefore should be protected by some means. However, the control surface can be such as a sensing surface and needs different type of protections from simply covering with a traditional screen shield. No conventional art suggests an effective way to achieve the demands.

### SUMMARY OF THE INVENTION

An object of this invention is to provide a protective film which flexibly covers the control surface and the switch surface separately or together for their scratch protection. Obvious advantages of this invention are to provide excellent scratch resistant effect, antifouling effect, and dirt or stain resistant effect. Also, the protective film of this invention may be made of a soft material which gives a shock absorbing effect and may be made of a transparent material which allows the user to access an instruction printed on the control surface and to allow fingerprint scanning. Furthermore, this protective film may be formed by simple die cutting, which reduces the manufacturing cost. For example, one adhesive layer and a non-adhesive layer are superposed each other, thereby forming one double-layer film sheet and allowing the die cutting.

To achieve the objectives, this invention provides the protective film comprising the first film which covers the switch surface of the electronic device and has the adhesive surface thereon and the second film, one surface thereof superposed on the adhesive surface and the other surface thereof placed on a predetermined portion of the electronic device.

This invention still provides the protective film comprising the first film which covers the control surface including the switch surface of the electronic device and has the adhesive surface and the second film, one surface thereof superposed on the adhesive surface and the other surface thereof placed on the predetermined portion of the control surface.

This invention still provides the protective film comprising the first film which covers the major front surface of electronic device and has the adhesive surface, and the second film, one surface thereof superposed on the adhesive surface and the other surface thereof placed on a predetermined portion of the electronic device.

The above protective film may be characterized in that the superposing portions of the first film surface and the second surface are shaped in correspondence to the switching surface. The switching surface may be raised. The protective film removable from the electronic device and resealable thereon. The protective film may have a protective shield for a screen. Furthermore, the protective film may be made of a flexible material and/or transparent material.

### BRIEF DESCRIPTION OF THE DRAWINGS

The above and other objects of the present invention will become readily apparent by reference to the following detailed description when considered in conjunction with the accompanying drawings wherein:

FIG. 1 is a perspective view of the protective film covering the control surface and the switch surface of a portable electronic device;

FIG. 2A is a side cross-section view of the protective film which covers the control surface and the switch surface of the portable electronic device;

FIG. 2B is a side cross-section view of the protective film after removing an adhesive film covering pieces therefrom;

FIG. 2C is a side cross-section view of the removed adhesive and non-adhesive film covering pieces;

FIG. 3 is a side cross-section of the protective film the control surface and the switch surface of the portable electronic device placed thereon;

FIG. 4 is a perspective view of the protective film coving the switch surface of the portable electronic device placed thereon; and

FIG. 5 is a perspective view of the protective film coving a major surface of the portable electronic device.

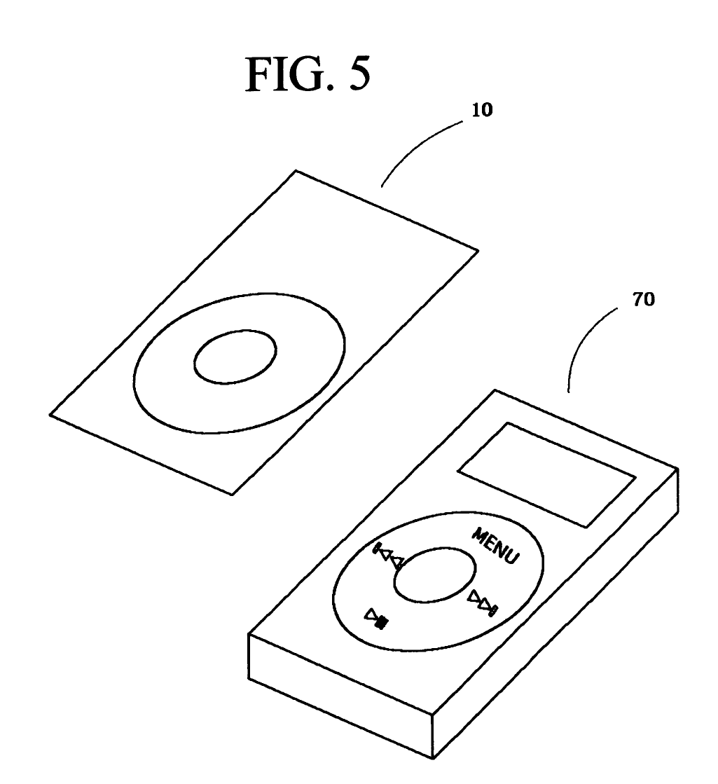

### DETAILED DESCRIPTION OF THE PREFERRED EMBODIMENTS

Next, preferred embodiments of this invention will be explained with reference to the accompanied drawings. Here, this invention is not limited by the preferred embodiments explained herein. Also, components of the following preferred embodiments may include one that is apparent to those skilled in the art or practically identical to the components herein. Also, the following explanation uses an example where the protective film is used on a portable music player; however, the usage of the protective film is not limited to such, and this invention can be employed in a various types of electronic devices.

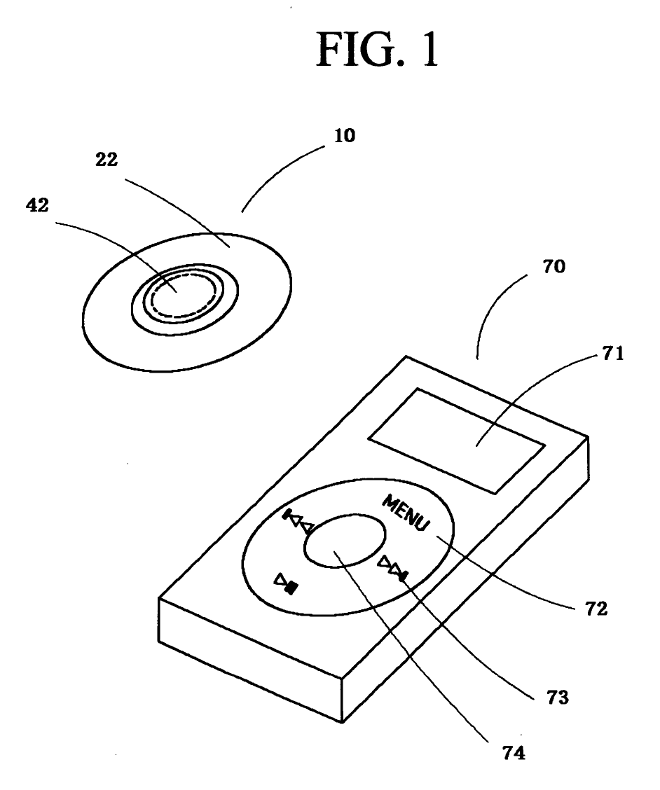

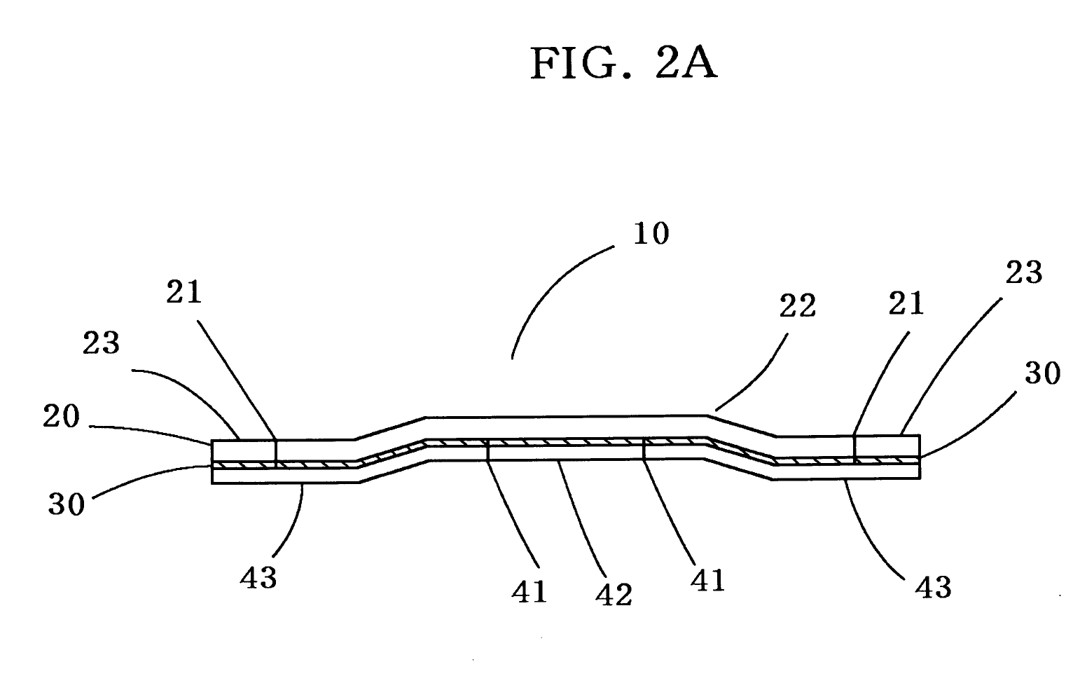

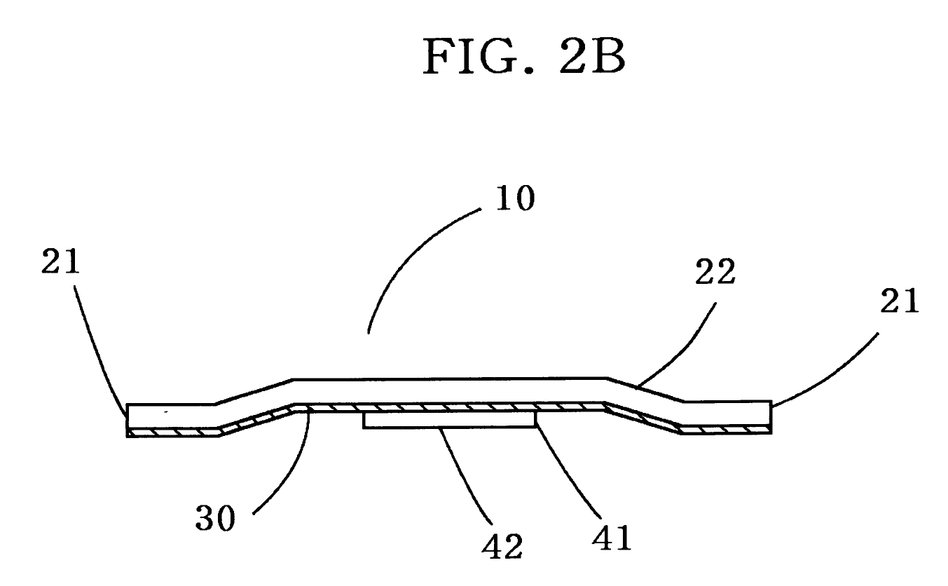

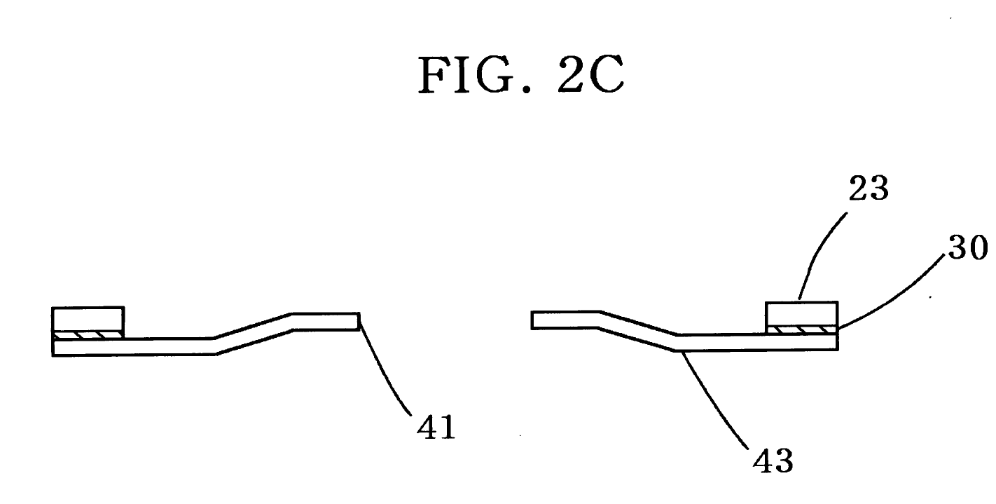

A first embodiment is explained with reference to FIGS. 1-3. FIG. 1 is the perspective view of the protective film covering the control surface and the switch surface 74 of a portable electronic device 70. FIG. 2A is the side cross-section view of the protective film which covers the control surface and the switch surface 74 of the portable electronic device 70.

The protective film 10 is comprised of a first layer 20 and a second layer 40. The first layer 20 has an adhesive surface 20 thereon and the second layer 30 is superposed on the adhesive surface 20 so that the adhesive surface 20 is sandwiched between the first and second layers 20, 40.

The first layer 20 has a first cut line 21 that enables to separate the first layer 20 into two pieces, i.e., a large surface cover 22 and a remaining piece 23. The shape and surface area of the first layer 20 can be decided as necessary. For example, as shown in FIG. 1, the first cut line 21 extends along a circumferential line of the control surface 72 of the electronic device 70, and therefore as separating the first layer 20 into two pieces at the circumferential line, the resulting first layer 20 makes an appropriate shape to cover the control surface 72 as appeared FIG. 1.

The first layer 20 of FIG. 2A shows the adhesive surface 30. The adhesive surface 30 can cover any area of the surface of the first layer 20 as long as the first layer 20 is securely attached on the surface of the electronic device 70 and also securely holds a later described switch surface cover 42.

The second layer 40 has a second cut line 41 to separate the second layer 40 into two pieces, i.e., a switch surface cover 42 and a non-adhesive film covering piece 43. The shape and surface area of the second layer 40 can be decided as necessary. For example, as shown in FIG. 1, the second cut line 41 extends along a circumferential line of the switch surface 74 of the electronic device 70, and therefore as separating the second layer 40 into two pieces at the circumferential line, the resulting second layer 40 makes an appropriate shape to cover the switch surface 74 as appeared FIG. 1.

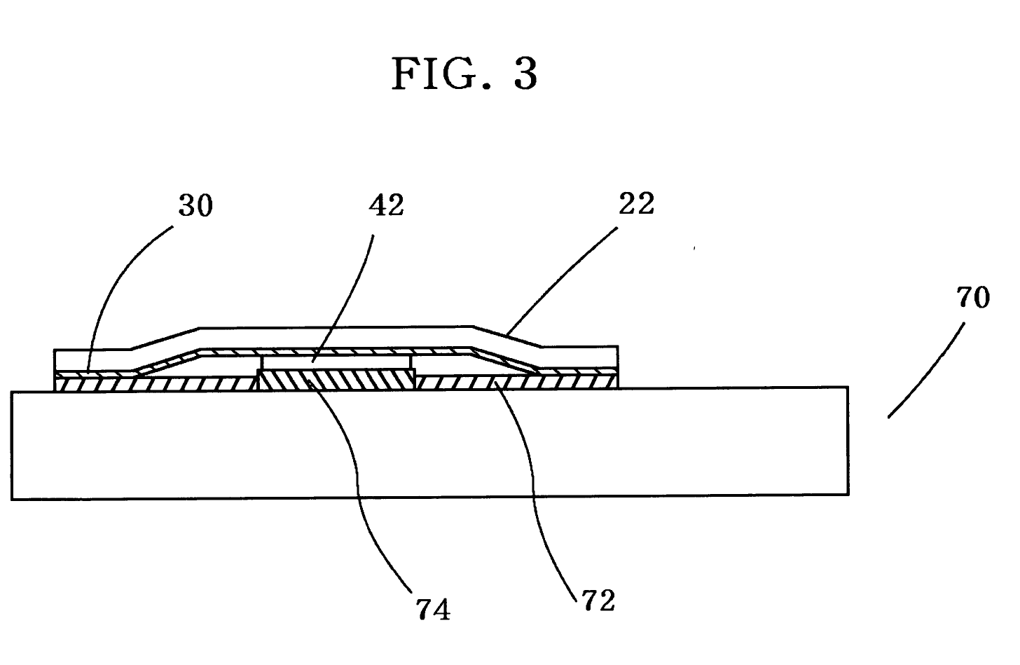

FIG. 2B is the side cross-section view of the protective film after removing an adhesive film covering pieces therefrom, and FIG. 2C is the side cross-section view of the removed adhesive and non-adhesive film covering pieces. FIG. 3 is the side cross-section of the protective film the control surface and the switch surface 74 of the portable electronic device 70 placed thereon. Initially, the switch surface cover 42 and the non-adhesive film covering piece 43 are securely attached to the first layer 20 via an adhesive force of the adhesive surface 30. As a user holds the edge of the first layer 20 and the second layer 40 approximately around the remaining piece 22, the user can carefully peel the first or second layers 20, 40, the first layer 20 and the second layer 40 are separate into two pieces. The remaining piece 22 and the non-adhesive film covering piece 43 maintaining their adhesion via adhesive layer 30, and the switch surface cove 42 and the first layer 20 also maintains their adhesion via adhesive layer 30 as shown in FIG. 2B. Thereafter, the first layer 20 with the switch cover 42 is placed on an appropriate surface of the electronic device 70 as appeared in FIG. 3.

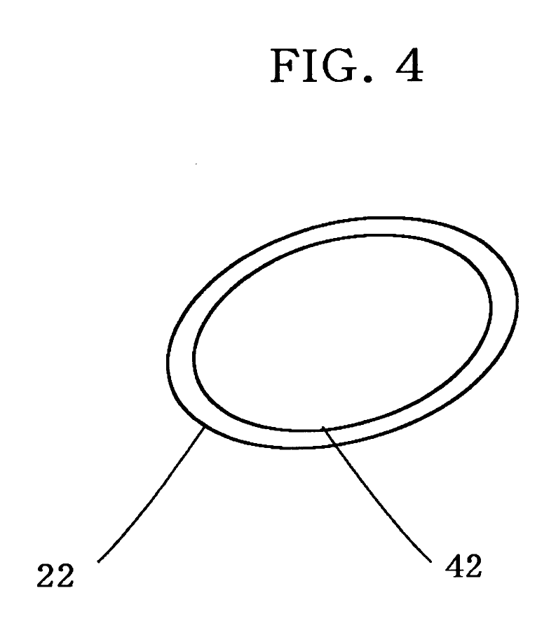

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Therefore, the protective film may be sized and shaped as necessary to fit a desirable portion of the electronic device 70 surface. For example, as shown in FIG. 4, which is the perspective view of the protective film coving the switch surface 74 of the portable electronic device 70 placed thereon, the protective film can simply cover the switch surface 74 only. By the same token, the protective film can cover beyond the control surface of the electronic device 70. Furthermore, the material of the protective film may be flexible to provide an appropriate fitness on the electronic device 70 surface and may be a transparent material so that the user is able to see instructions or signs 73 marked on the electronic device 70 surface. Accordingly, reference should be made to the following claims in determining the full scope of the invention.

What is claimed is:

1. A protective film comprising
a first film which covers a switch surface of an electronic device and has an adhesive surface thereon and
a second film, one surface thereof superposed on said adhesive surface and the other surface thereof placed on a predetermined portion of said electronic device.

2. A protective film comprising
a first film which covers a control surface including a switch surface of an electronic device and has an adhesive surface and
a second film, one surface thereof superposed on said adhesive surface and the other surface thereof placed on a predetermined portion of said control surface.

3. A protective film comprising
a first film which covers a surface of electronic device and has an adhesive surface, and
a second film, one surface thereof superposed on said adhesive surface and the other surface thereof placed on a predetermined portion of said electronic device.

4. The protective film according to claim 1, wherein
said superposing portions of the first film surface and the second surface are shaped in correspondence to the switching surface.

5. The protective film according to claim 2, wherein
said superposing portions of the first film surface and the second surface are shaped in correspondence to the switching surface.

6. The protective film according to claim 3, wherein
said superposing portions of the film surface and the second surface are shaped in correspondence to the switching surface.

7. The protective film according to claim 1, wherein
said switching surface is raised.

8. The protective film according to claim 2, wherein
said switching surface is raised.

9. The protective film according to claim 2, wherein
said switching surface is raised.

10. The protective film according to claim 1, wherein
said protective film is removable from the electronic device and resealable thereon.

11. The protective film according to claim 2, wherein
said protective film is removable from the electronic device and resealable thereon.

12. The protective film according to claim 3, wherein
said protective film is removable from the electronic device and resealable thereon.

13. The protective film according to claim 3, wherein
said protective film has a protective shield for a screen.

14. The protective film according to claim 1, wherein
said protective film is made of a flexible material.

15. The protective film according to claim 2, wherein
said protective film is made of a flexible material.

16. The protective film according to claim 3, wherein
said protective film is made of a flexible material.

17. The protective film according to claim 1, wherein
said protective film is made of a transparent material.

18. The protective film according to claim 2, wherein
said protective film is made of a transparent material.

19. The protective film according to claim 3, wherein
said protective film is made of a transparent material.
